(19) United States
(12) Patent Application Publication
(10) Pub. No.: US 2007/0211066 A1
(43) Pub. Date: Sep. 13, 2007

(54) SCREEN DISPLAY CONTROL APPARATUS AND PROGRAM PRODUCT

(75) Inventor: Hirokazu Kanda, Ome-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: CASIO COMPUTER CO., LTD., Tokyo (JP)

(21) Appl. No.: 11/683,763

(22) Filed: Mar. 8, 2007

(30) Foreign Application Priority Data
Mar. 9, 2006 (JP) 2006-063965

(51) Int. Cl. G09G 5/39

(52) U.S. Cl. 345/531; 345/684

(57) ABSTRACT

A screen display control apparatus receives screen update information which represents content of display update. Screen image is updated in an update area in accordance with the received screen update information. When the update area is not in a display range of the display screen and a size of the update area is greater than a predetermined size, the display range of the display screen is moved in order that the display range contains the update area.

### CROSS-REFERENCE TO RELATED APPLICATIONS

This application is based upon and claims the benefit of priority from prior Japanese Patent Application No. 2006-063965, filed Mar. 9, 2006, the entire contents of which are incorporated herein by reference.

### BACKGROUND OF THE INVENTION

1. Field of the Invention

The present invention relates to a screen display control apparatus and a program product for a small display screen.

2. Description of the Related Art

In a client server system, an operating system (OS) of a server provides a graphical user interface (GUI) assuming that a client terminal is equipped with a display screen having a predetermined size. When the client includes a display screen which is smaller than the predetermined size, it is necessary for the client to reduce a size of a display image of the GUI or to scroll a display range. For example, Jpn. Pat. Appln. KOKAI Publication No. 9-044338 discloses an apparatus which enables an easy selection of an object on the display image even in the case where the size of the display screen is not sufficient to display the image.

If the client reduces a display size of the display image in order that the entire display image which is provided by the server can be displayed in the display screen of the client terminal, sizes of displayed contents such as characters and icons are reduced and the display contents become hard to be read out.

To show the entire display image without the operability deterioration, the client terminal may scroll a display range of the display image. A portion which is not contained in the display screen of the client terminal can be shown by the scrolling. However, every time the display content on the display image is updated, it is required to scroll manually the display range of the client terminal.

### BRIEF SUMMARY OF THE INVENTION

According to an embodiment of the present invention, a display control apparatus for a display device which is configured to display a partial image of a screen image, the partial image being in a display range, the apparatus comprises:

a receiving unit which is configured to receive update information which instructs partial update of the screen image;

an update unit which is configured to partially update the screen image in accordance with the received update information; and

a display controller which is configured to move the display range in the screen image such that the display device displays an image of an update area of the screen image when the update area is out of the display range and a size of the update area is larger than a predetermined size.

According to another embodiment of the present invention, a display control apparatus for a display device which is configured to display a partial image of a screen image, the partial image being in a display range, the apparatus comprises:

a receiving unit which is configured to receive update information which instructs partial update of the screen image;

an update unit which is configured to partially update the screen image in accordance with the received update information; and

a display controller which is configured to move the display range in the screen image such that the display device displays an image of an update area of the screen image when the update area is out of the display range and the image in the update area has a predetermined attribute.

According to another embodiment of the present invention, a display control apparatus for a display device which is configured to display a partial image of a screen image, the partial image being in a display range, the apparatus comprises:

a receiving unit which is configured to receive a storage instruction which instructs storage a part of the screen image;

a storage unit which is configured to store the part of the screen image in accordance with the storage instruction; and

a display controller which is configured to move the display range in the screen image such that the display device displays a stored image which is stored by the storage unit when the stored image is out of the display range and a size of the stored image is larger than a predetermined size.

According to another embodiment of the present invention, a display control apparatus for a display device which is configured to display a partial image of a screen image, the partial image being in a display range, the apparatus comprises:

a detection unit which is configured to detect a difference between first image data and second image data;

a determination unit which is configured to determine whether or not a size of a differential area between the first image data and the second image data is greater than a predetermined size; and

a display controller which is configured to move the display range in the screen image such that the display device displays an image of the differential area when the determination unit determines that the size of the differential area is greater than the predetermined size.

According to another embodiment of the present invention, a computer program for a display control apparatus for a display device which is configured to display a partial image of a screen image, the partial image being in a display range, the program being stored in a computer readable medium, and the program comprises:

receiving update information which instructs partial update of the screen image;

partially updating the screen image in accordance with the received update information; and

moving the display range in the screen image such that the display device displays an image of an update area of the screen image when the update area is out of the display range and a size of the update area is larger than a predetermined size.

According to another embodiment of the present invention, a computer program for a display control apparatus for a display device which is configured to display a partial image of a screen image, the partial image being in a display range, the program being stored in a computer readable medium, and the program comprises:

receiving update information which instructs partial update of the screen image;

partially updating the screen image in accordance with the received update information; and

moving the display range in the screen image such that the display device displays an image of an update area of the screen image when the update area is out of the display range and the image in the update area has a predetermined attribute.

According to another embodiment of the present invention, a computer program for a display control apparatus for a display device which is configured to display a partial image of a screen image, the partial image being in a display range, the program being stored in a computer readable medium, and the program comprises:

receiving a storage instruction which instructs storage a part of the screen image;

storing the part of the screen image in accordance with the storage instruction; and

moving the display range in the screen image such that the display device displays a stored image which is stored by the storage unit when the stored image is out of the display range and a size of the stored image is larger than a predetermined size.

According to another embodiment of the present invention, a computer program for a display control apparatus for a display device which is configured to display a partial image of a screen image, the partial image being in a display range, the program being stored in a computer readable medium, and the program comprises:

detecting a difference between first image data and second image data;

determining whether or not a size of a differential area between the first image data and the second image data is greater than a predetermined size; and

moving the display range in the screen image such that the display device displays an image of the differential area when it is determined that the size of the differential area is greater than the predetermined size.

### BRIEF DESCRIPTION OF THE SEVERAL VIEWS OF THE DRAWING

The accompanying drawings, which are incorporated in and constitute a part of the specification, illustrate embodiments of the present invention and, together with the general description given above and the detailed description of the embodiments given below, serve to explain the principles of the present invention in which:

FIG. 1 is a schematic view showing an external configuration of a client server system according to first through third embodiments;

FIG. 2 is a view for explaining relationship in size between a screen image G1 of a server 20 and a screen image G2 of a client terminal 10;

FIG. 3 is a flow chart of a screen display control process according to the first embodiment;

FIG. 4 is a flow chart of a screen display control process according to the second embodiment;

FIG. 5 is a flow chart of a screen display control process according to the third embodiment;

FIG. 6 is a schematic front view showing an external configuration of the client 10 and a digital camera 30 according to a fourth embodiment;

FIG. 7 is a view for explaining the relationship between a size of an image stored in a display buffer and a size of display range of the client terminal 10;

FIG. 8 is a flow chart of a screen display control process according to the fourth embodiment;

FIG. 9 is a diagram showing an example of a screen image G1 of the server 20;

FIG. 10 is a diagram showing an example of a screen image G2 of the client terminal; and

FIG. 11 is a schematic block diagram showing an electric configuration of the server and the client terminal.

### DETAILED DESCRIPTION OF THE INVENTION

Embodiments of a screen display control apparatus according to the present invention will now be described with reference to the accompanying drawings.

### First Embodiment

### (1) Structure

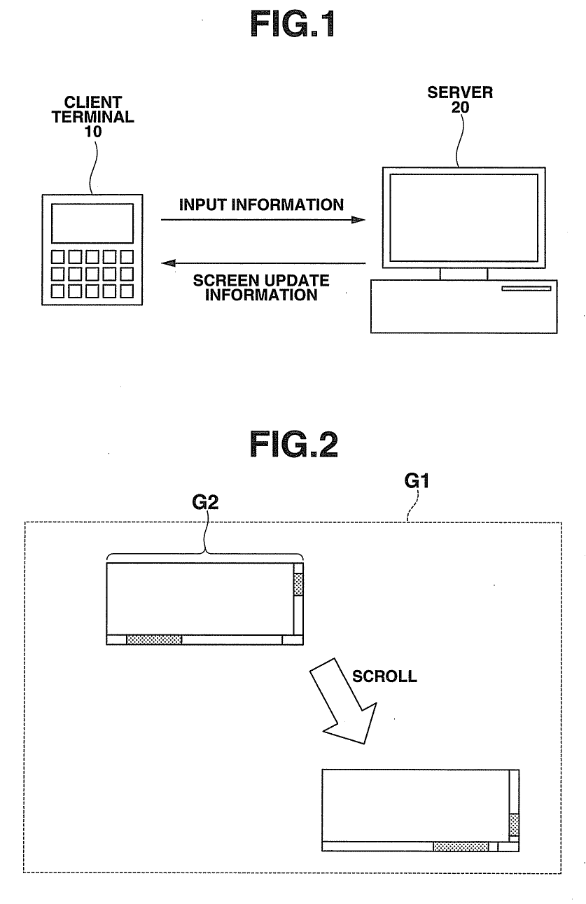

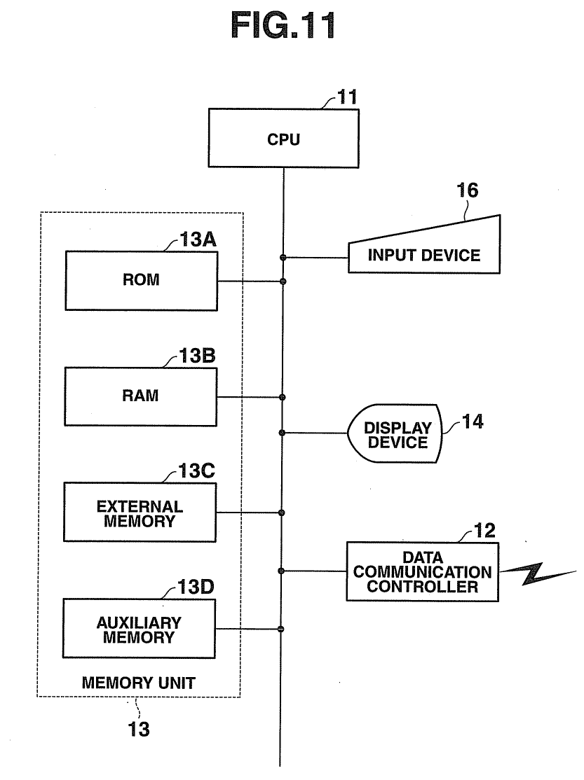

FIG. 1 is a schematic view showing an external configuration of a client server system. The client server system shown in FIG. 1 includes a server 20 and a client terminal 10. The client terminal 10 is connected to the server 20. The client terminal 10 and the server 20 have the same basic structure as a personal computer which is commonly known. FIG. 11 is a schematic block diagram showing an electric configuration of the client terminal 10 and the server 20. As shown in FIG. 11, the client terminal 10 and the server 20 comprises a CPU 11, a data communication controller 12, a memory unit 13, a display device 14, and an input device 16. The components of the client terminal 10 or the server 20 are interconnected via a bus. The CPU 11 controls operations of the components. The data communication controller 12 controls transmission and reception of data. The memory unit 13 includes memory devices such as a read only memory (ROM) 13A, a random access memory (RAM) 13B, an external memory 13C, and an auxiliary memory 13D. The memory unit 13 stores programs for executing a variety of process in the client terminal 10 and the server 20. In addition, the memory unit 13 stores a variety of data such as a data file. The CPU 11 controls the display device 14 in order to display an image or other information. The CPU 11 controls the input device 16 for inputting various data and signals. The server 20 provides a GUI (screen image G1) and a display device 14 of the client terminal 10 is equipped with a small display screen which displays only a partial image G2 of the GUI G1. Therefore, the client terminal 10 scrolls a display range of the screen image. Accordingly, the entire GUI may be displayed by the display device 14 of the client terminal 10.

The CPU 11 of the client terminal 10 executes a screen display control process according to the present embodiment. The screen display control process is realized by execution of a program to be described later under the control of the CPU 11 of the client terminal 10. Specifically, in the client terminal 10, when a user operates the input device 16 (such as a keyboard or a mouse), an input signal is generated depending on the operation of the user. The CPU 11 controls the generated input signal as input information. The data communication controller 12 of the client terminal 10 sends the input information to the server 20. The server 20 executes a predetermined application program based on the input information delivered from the client terminal 10. The execution of the application program generates screen update information. The generated screen update information is returned to the client terminal 10. The client terminal 10 executes the screen display control process in accordance with the screen update information send from the server 20. The CPU 11 of the client terminal 10 controls the display content based on the screen update information in order that the display content may be automatically scroll-displayed on the display screen of the display device 14.

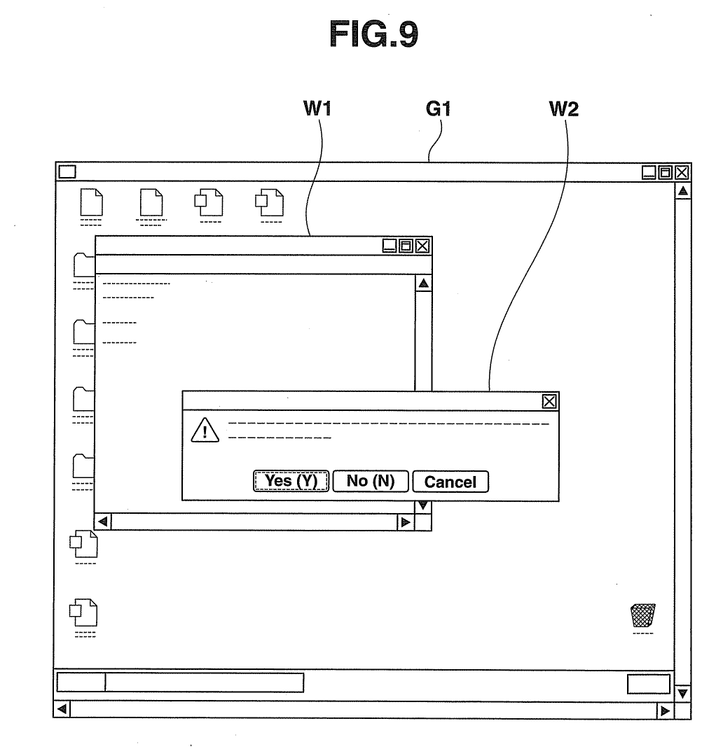

The server 20 generates screen update information and sends it to the client terminal 10. The screen update information represents general data which is supposed to be displayed on the screen image G1 having a size shown in FIG. 9. For example, when the screen update information is generated in order to draw a simple graphic (straight line or rectangle) on the screen image G1, a draw command is considered as the screen update information. The draw command designates a draw size of the graphic and a coordinate value which represents a display position. When screen-updating for displaying a complex graphic or a natural image such as a photograph or a graphic image, image data in a predetermined data format and a coordinate value which represents a display position are considered as the screen update information. The predetermined data format is interpretable by both the client terminal 10 and the server 20 (e.g., jpeg or bmp format). The draw size of the graphic can be recognized from header information of the image data.

### (2) Operation

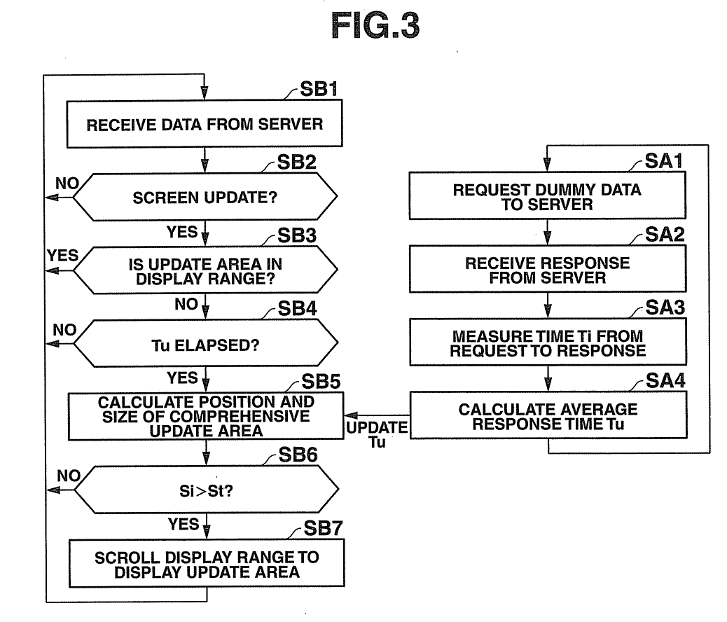

Next, referring to FIG. 3, a description is given of the operation of the screen display control process which is executed under the control of the CPU 11 of the client terminal 10 based on the program stored in the memory unit 13. The screen display control process includes a response time calculation thread comprising steps SA1 to SA4, and a scroll-control thread comprising steps SB1 to SB7.

### <Operation of Response Time Calculation Thread>

The response time calculation thread is executed at a predetermined time interval after the client terminal 10 is connected to the server 20. At an execution timing of the response time calculation thread, the flow goes to step SA1 and a request is send to the server 20 to transmit image data having a predetermined size. The requested image data is not image data to be actually displayed on the screen, but dummy data which is used for calculation of an average response time Tu described later.

In following step SA2, the client terminal 10 receives the image data which the server 20 sends in response to the request in step SA1. In step SA3, a response time Ti is measured. The response time Ti is time between requesting data transmission in step SA1 and receiving the data in step SA2. In step SA4, an average response time Tu is calculated based on the several measurement results of Ti measured in step SA3 in prior execution of the response time calculation thread. An effective range is preset for the measurement of the response time in step SA3. When the measured response time Ti exceeds the effective range, the measured response time Ti is not used for the calculation of the average response time Tu.

### <Operation of Scroll-Control Thread>

The scroll-control thread is started when the client terminal 10 is connected to the server 20. When starting the operation of the scroll-control thread, the flow goes to step SB1 and the client terminal 10 receives data from the server 20. In step SB2, it is determined whether or not the data which the client terminal 10 received in step SB1 is the screen update information. When it is determined that the received data is not the screen update information, the determination result is “NO”, and the flow returns to step SB1.

On the other hand, when it is determined that the data received from the server 20 is the screen update information, the determination result in step SB2 is “YES” and the flow goes to step SB3. In step SB3, screen image to be displayed on the display screen is updated based on the received screen update information. The updating of the screen image is performed by drawing the graphic or pasting the image data on the screen image at the position indicated by the coordinate value. The area in which the screen image is updated is called “update area.” In addition, it is determined whether or not the entire update area is included in the display range G2 of the display screen of the client terminal (see FIG. 2) in step SB3.

In the case where the entire update area is in the display range G2 of the display screen, i.e., when an image of the entire update area is visible, the determination result in step SB3 is “YES” and the flow returns to step SB1. On the other hand, in the case where the update area is not in the display range G2 of the display screen, i.e., when there is an invisible portion of the updated area, the determination result is “NO” and the flow goes to step SB4. In step SB4, it is determined whether or not the average response time Tu is elapsed. If No, the flow returns to step SB1, and if YES, the flow advances to step SB5.

In step SB5, the display position (coordinates) and a draw size Si of a comprehensive update area including all of the update areas which are determined outside the display range G2 of the display screen in step SB3 are calculated on the basis of the screen update information acquired during the average response time Tu which starts with the execution of step SA1.

For example, the following draw commands are acquired as the screen update information:

Coordinates (800, 800), width 10, height 10;

Coordinates (810, 830), width 50, height 20;

Coordinates (805, 800), width 30, height 40;

where a draw command instructs to draw a graphic using coordinates (x, y), a width and a height. The coordinates (x, y) represents coordinates of a lower left point of a rectangular area. The width represents a length in the x direction and the height represents a length in the y direction of the rectangular area.

Accordingly, the display position of the comprehensive area is expressed by coordinates (800, 800). The draw size Si of the comprehensive area is expressed by (width 60, height 50).

In step SB6, it is determined whether or not the size Si (width, height) of the comprehensive area calculated in step SB5 is greater than a preset threshold St. When the calculated size Si of the comprehensive area is less than the threshold St, the determination result is “NO” and the flow returns to step SB1. When the size Si of the comprehensive area is less than the threshold St, the screen-updating is considered less important. Namely, a minor screen-updating such as a cursor blink or the like is not necessary, and the flow returns to step SB1.

On the other hand, when the calculated size Si of the comprehensive area is greater than the threshold St, the screen-updating is considered important. The determination result in step SB6 is “YES” and the flow goes to step SB7. In step SB7, scroll-control is performed as follows. That is, the display range G2 of the display screen is scrolled in the screen image. The display range is set in such a manner that the image of the comprehensive area is displayed at the center of the display range G2 if the former is smaller than the latter or the upper left corner of the comprehensive area coincides with the upper left corner of the display range G2 if the former is larger than the latter. Thus, the display device 14 of the client terminal 10 may scroll-display the image of the comprehensive area. Thereafter, the flow returns to step SB1.

As described above, in the present embodiment, the client terminal 10 executes the response time calculation thread to calculate the average response time Tu of the server 20, and executes the scroll-control thread to update the display data on the basis of the screen update information. When the comprehensive area is not in the display range G2 of the display screen and becomes invisible, the display position (coordinates) and the draw size Si (width, height) of the comprehensive area are calculated on the basis of the screen update information which is received during the average response time Tu. When the calculated size Si (width, height) of the comprehensive area is greater than the preset threshold St, the screen-updating is considered to be important. The display range G2 of the display screen is scrolled in the screen image to display an image of the comprehensive area (see FIG. 2). The comprehensive area to be scroll-displayed is specified by the coordinates (display position) and the draw size Si (width, height) contained in the screen update information. Thereby, the updated display content may be scroll-displayed automatically.

When the draw size Si (width, height) of the comprehensive area, which is calculated on the basis of the screen update information acquired during the average response time Tu, is less than the preset threshold St, the scroll-control is not performed. Thereby, the unimportant screen-updating such as the blink of the cursor can be prevented from occurring.

In the present embodiment, as the determination condition for determining whether or not the scroll-control is required, the draw size Si (width, height) of the comprehensive area for the average response time Tu is employed. The determination may be performed additionally considering the color information contained in the comprehensive area and the shape of the comprehensive area. Further, it is possible to scroll each of the update areas not the comprehensive area.

In the present embodiment, when executing the scroll-control in step SB7, the display range G2 of the display screen is controlled in such a manner that the upper left corner of the display range G2 coincides with the upper left corner of the comprehensive update area. However, the center of the comprehensive update area may coincide with the center of the display range G2 even if the comprehensive update area is larger than the display range G2. Other corners or points of the display range G2 and the comprehensive update area may coincide with each other. The allocation of the display range G2 and the comprehensive update area may be determined according to the display size Si of the comprehensive update area.

Other embodiments of the client sever system according to the present invention will be described. The same portions as those of the first embodiment will be indicated in the same reference numerals and their detailed description will be omitted.

### Second Embodiment

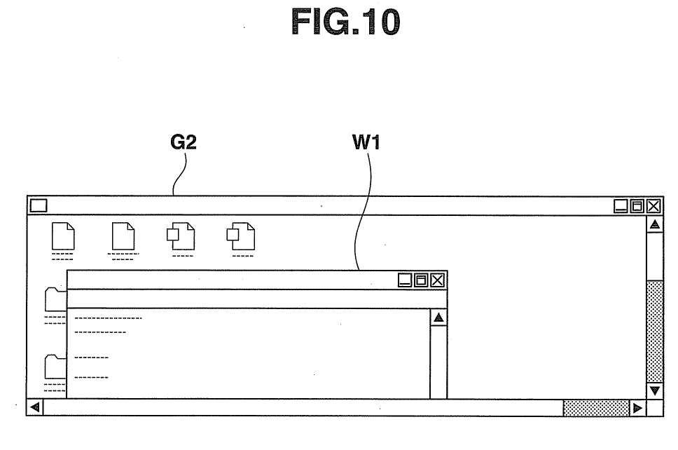

The server 20 provides a GUI (screen image G1) having the size shown in FIG. 2. The client terminal 10 is equipped with the display screen having a display range G2 shown in FIG. 2 which is smaller than the screen image G1. FIG. 9 is a diagram showing an example of a screen image G1 including two windows W1 and W2. FIG. 10 is a diagram showing an example of a display image G2 of the display device of the client terminal. The server 20 instructs the client terminal 10 to display a pop-up window W2 in response to a command input from the client terminal 10. In the command, it is assumed that the pop-up window W2 is to be displayed in the screen image G1 whereas the display range G2 of the client terminal 10 is smaller than the screen image G1. Accordingly, as shown in FIG. 10, the pop-up window W2 cannot be displayed on the screen image G2 and becomes invisible.

In the case where a “selection” button is allocated on the pop-up window W2, it may be brought about that the subsequent operation cannot be started unless the “selection” button is clicked. When the pop-up window W2 is invisible in the display range G2 as described above, the user cannot click the “selection” button. Thereby, the user may misunderstand that the operation of the client terminal 10 is locked up. In the present embodiment, in order to avoid the invisibility of the pop-up window W2 in the display range G2, a screen display control process is performed as follows. That is, when a “Yes (Y)” button is detected in screen image G1 when screen-updating (when displaying the pop-up window W2), the display range G2 of the client terminal is scroll-controlled so as to display an image of the update area including the “Yes (Y)” button.

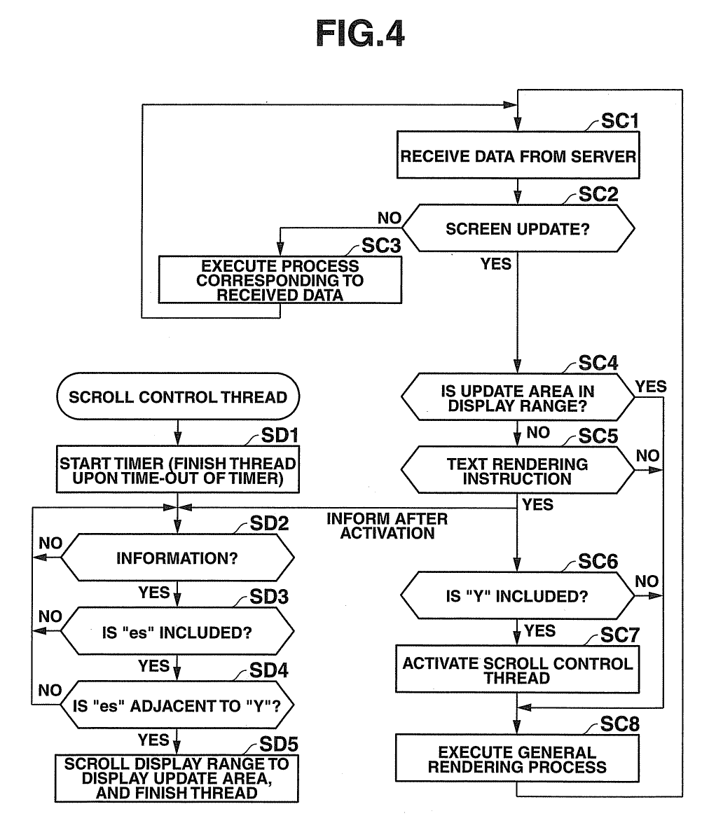

Referring to FIG. 4, the operation of the screen display control process according to the present embodiment will be described. The screen display control process is realized by execution of a program stored in the memory unit 13 under the control of the CPU 11 of the client terminal 10. The screen display control process includes a graphic draw thread comprising steps SC1 to SC8, and a scroll-control thread comprising steps SD1 to SD5.

### <Operation of Graphic Draw Thread>

The graphic draw thread is started when the client terminal 10 is connected to the server 20. When executing the graphic draw thread, the flow goes to step SC1 and the client terminal 10 receives data from the server 20. In subsequent step SC2, it is determined whether or not the received data is the above-described screen update information. When the received data is not the screen update information, the determination result is “NO” and the flow goes to step SC3. In step SC3, the client terminal 10 executes a process corresponding to the received data, and the flow returns to step SC1.

On the other hand, when the received data is the screen update information, the determination result in step SC2 is “YES” and the flow goes to step SC4. In step SC4, it is determined whether or not the entire update area is in the display range G2 (see FIG. 2). When screen-updating, the screen image is partially updated in the update area according to the screen update information received from the server 20. When it is determined that the entire update area is in the display range G2, the determination result in step SC4 is “YES” and the flow goes to step SC8. In step SC8, a general graphic draw process is executed by drawing a graphic or pasting image data at the display position designated by the coordinates included in the screen update information received from the server 20. Thereafter, the flow returns to step SC1.

On the other hand, when the entire update area is not in the display range G2 and becomes invisible, the determination result in step SC4 is “NO”. The flow goes to step SC5. In step SC5, it is determined whether or not the screen update information received from the server 20 contains a text display instruction. The text display instruction designates a text to be displayed inside of a button, coordinates (x, y) which represents the display position of the button, and a draw size (width, height) of the button.

When the screen update information does not include the text display instruction, the determination result in step SC5 is “NO” and the flow goes to step SC8. In step SC8, the general graphic draw process is executed by drawing a graphic or pasting image data at the display position designated by the coordinates included in the screen update information received from the server 20. Thereafter, the flow returns to step SC1. On the other hand, when the screen update information received from the server 20 includes the text display instruction, the determination result in step SC5 is “YES” and the flow goes to step SC6. The text display instruction is reported to the scroll-control thread (which is described later).

In step SC6, it is determined whether or not a character “Y” is included in the text to be displayed according to the text display instruction. When the “Y” is not included, the determination result is “NO”, and the text to be displayed is considered not to be the “Yes (Y)” button. The flow goes to step SC8 and the general graphic draw process is executed. Thereafter, the flow returns to step SC1. On the other hand, when the “Y” is included in the text to be displayed according to the text display instruction, the determination result in step SC6 is “YES” and the flow goes to step SC7 to start the scroll-control thread. Then, the flow goes to step SC8 and the general graphic draw process is executed.

### <Operation of Scroll-Control Thread>

When the scroll-control thread is activated by the process of step SC7 in the above graphic draw thread, the flow goes to step SD1 and a timer is started up (step SD1). When the timer counts up a predetermined time period, the process of the scroll-control thread is terminated. In step SD2, the process stands by for the reception of the text display instruction reported from the graphic draw thread. When the text display instruction is sent from the graphic draw thread, the determination result is “YES” and the flow goes to step SD3.

In step SD3, it is determined whether or not characters “es” is included in the text to be displayed according to the received text display instruction. When the “es” are not included, the text to be displayed is considered not to be the “Yes (Y)” button and the determination result is “NO”. The flow returns to step SD2, and waits to receive the text display instruction from the graphic draw thread until the timer counts up the predetermined time period. When the “es” are included in the text, the determination result is “YES” and the flow goes to step SD4.

In step SD4, it is determined whether or not the characters “es” neighbors at right side upon the “Y” in the text, that is, whether or not the text is considered as the “Yes (Y)” button. When it is determined that the text is not considered as the “Yes (Y)” button, the determination result is “NO” and the flow returns to step SD2 to wait for the text display instruction. When the text is the “Yes (Y)” button, the determination result becomes “YES” and the flow goes to step SD5. In step SD5, the display range G2 is scroll-controlled. The scroll-control is executed in order that the display screen of the client terminal may display the “Yes (Y)” button contained in the update area in accordance with the screen update information. Thus, the scroll-control thread is terminated.

As described above, in the present embodiment, in the case where the text display instruction for the “Yes (Y)” button is detected when screen-updating (i.e., when displaying the pop-up window), the display range of the client terminal is scroll-controlled in order that the update area including the “Yes (Y)” button may be displayed by the client terminal. Accordingly, the display content to be updated can be automatically scroll-displayed. Moreover, the invisibility of the pop-up window can be avoided as a result of the automatic scroll-display of the update area including the “Yes (Y)” button on the display screen G2. Thereby, it can be avoided that the user misunderstands that the client terminal 10 is locked up owing to the invisibility of the pop-up window.

### Third Embodiment

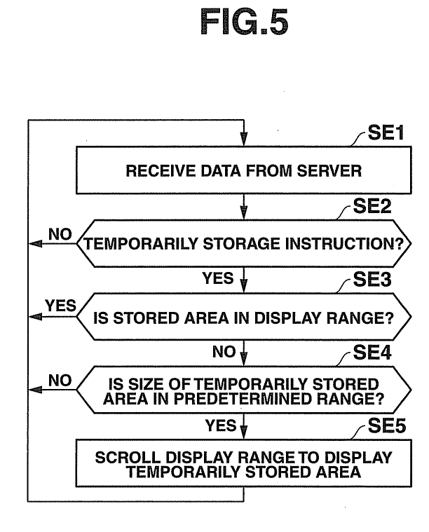

Subsequently, with reference to FIG. 5, a description is given of the operation of a screen display control process according to the present embodiment. The screen display control process is realized by execution of a program stored in the memory unit 13 under the control of the CPU 11 of the client terminal 10. When the client terminal 10 is connected to the server 20, the flow goes to step SE1 and receives data from the server 20. In following step SE2, it is determined whether or not the data received from the server 20 is a temporary storage instruction. The temporary storage instruction instructs the client terminal 10 to temporarily store a partial image of the screen image G1. When the data received from the server 20 is not the temporary storage instruction, the determination result is “NO” and the flow returns to step SE1.

On the other hand, when the data received from the server 20 is the temporary storage instruction, the determination result in step SE2 is “YES” and the flow goes to step SE3. In step SE3, the partial image of the screen image is temporarily stored in response to the temporary storage instruction received from the server 20. Thereafter, it is determined whether or not the temporarily stored partial image is in the display range G2 (see FIG. 2).

When the temporarily stored partial image is in the display range G2, the determination result is “YES” and the flow returns to step SE1. On the other hand, when the temporarily stored partial image is not in the display range G2, the determination result is “NO” and the flow goes to step SE4. In step SE4, it is determined whether or not the size of the partial image which is temporarily stored is in a preset size.

The preset size of the partial image may set to, for example, the display range of the pop-up window W2 (see FIG. 9). Namely, in step SE4, it is determined whether or not the temporarily stored partial image corresponds to the pop-up window W2. When it is determined that the partial image does not correspond to the pop-up window W2, the determination result is “NO” and the flow returns to step SE1. When the temporarily stored partial image corresponds to the pop-up window W2, the determination result is “YES” and the flow goes to step SE5. In step SE5, the display range G2 is scroll-controlled in order to display the temporarily stored partial image, i.e., the pop-up window W2. Then, the flow returns to step SE1.

As described above, in the present embodiment, when it is determined that the data received from the server 20 is the temporary storage instruction, a partial image of the screen image G1, is temporarily stored. Further, it is determined whether or not the temporarily stored partial image is in the display range G2 (see FIG. 2). When the temporarily stored partial image is not in the display range G2, it is determined whether or not the partial image is in the preset range (corresponding to the pop-up window W2). When the partial image corresponding to the pop-up window W2 is temporarily stored, the display range is scroll-controlled on the screen image G1 in order that the update area including the pop-up window W2 can be displayed. Thus, the display content can automatically be scrolled to display update image.

### Fourth Embodiment

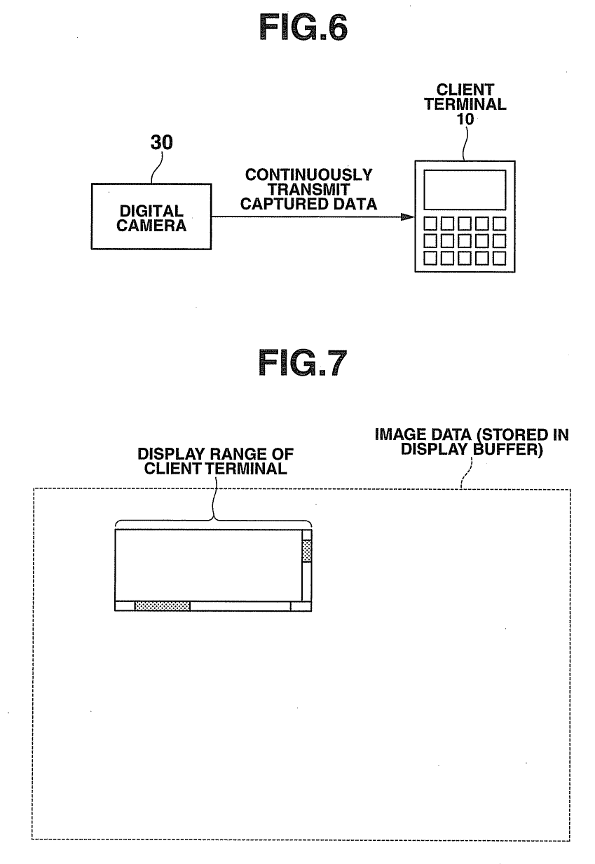

Another embodiment of the present invention is described with reference to FIG. 6 to FIG. 8. In the present embodiment, as shown in FIG. 6, a digital camera 30 is connected to the client terminal 10 via a universal serial bus (USB). The digital camera 30, such as a security camera, transmits captured data (image data) to the client terminal 10 at a predetermined time interval. The client terminal 10 receives and displays the data.

In the client terminal 10, the memory unit 13 includes a reception buffer and a display buffer (not shown in FIG. 2). In the client terminal 10, while the reception buffer stores image data transferred from the digital camera 30 at predetermined time intervals, image data to be displayed is read out from the reception buffer and is stored in the display buffer. As shown in FIG. 7, the display screen of the client terminal 10 is smaller than the size of the image data stored in the display buffer. Accordingly, a part of the image data, which corresponds to the display screen of the client terminal 10, is read out from the display buffer and displayed on the display screen.

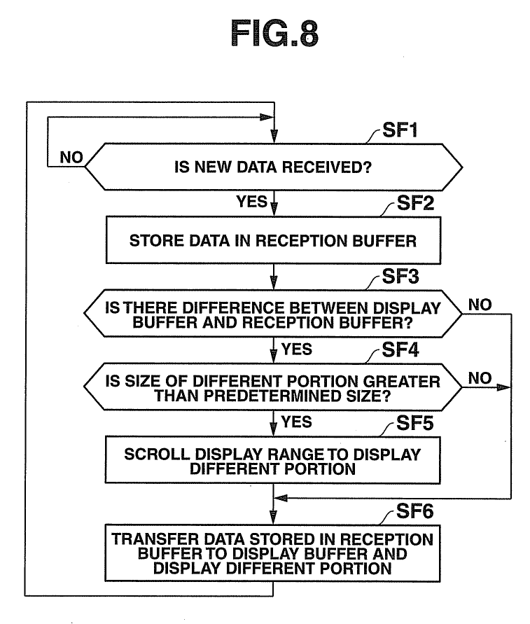

In order to display the entire image data stored in the display buffer, it is necessary to execute scroll-control of the display range of the display device 14. Therefore, when displaying the entire image data transferred from the digital camera 30, a scroll operation is required to be performed every time the new image data is transferred. In the present embodiment, a screen display control process illustrated in FIG. 8 is executed for automatic scroll-display. Referring to FIG. 8, a description is given of the operation of the screen display control process according to the present embodiment. The screen display control process is executed under the control of the CPU 11 of the client terminal 10.

In step SF1, it is waited that new image data is transferred from the digital camera 30. When the client terminal 10 receives the new transferred image data, the determination result in step SF1 is “YES” and the flow goes to step SF2. In step SF2, the received image data is stored in the reception buffer. Then, in step SF3, it is determined whether or not there is any difference between the previously received image data stored in the display buffer and the currently received image data stored in the reception buffer.

When there is no difference between the previously received image data and the currently received image data, the determination result is “NO” and the flow goes to step SF6. In step SF6, the currently received image data, which is stored in the reception buffer, is stored in the display buffer. The partial image data (currently received image data) corresponding to the display range (visible range) is read out from the display buffer and is displayed on the display screen. Then, the flow returns to step SF1.

On the other hand, when there is a difference between the previously received image data and the currently received image data, the determination result in step SF3 is “YES” and the flow goes to step SF4. In the security camera for capturing the image at the predetermined time interval, the background of the image does not change and the object, such as a person changes. In step SF4, it is determined whether or not the size of a different portion is greater than a predetermined size. The previously received image data and the currently received image data are different from each other in the different portion. When the size of the different portion is less than the predetermined size, the determination result is “NO” and the flow goes to step SF6. In step SF6, the currently received image data, which is stored in the reception buffer, is written in the display buffer. The partial image data (currently received image data) corresponding to the display range (visible range) is read out from the display buffer and is displayed on the display screen. Then, the flow returns to step SF1.

When the size of the different portion is greater than the predetermined size, the determination result in step SF4 is “YES” and the flow goes to step SF5. In step SF5, scroll-control is performed. Namely, the display range of the display screen G2 is scrolled through the image data in such a manner that the display range includes the different portion. The flow then goes to step SF6. In step SF6, the currently received image data subjected to the scroll-control, which is stored in the reception buffer, is written in the display buffer. The partial image data (currently received image data) corresponding to the scroll-controlled display range (visible range) is read out from the display buffer and is displayed on the display screen. Then, the flow returns to step SF1.

As described above, in the present embodiment, every time the client terminal 10 receives the image data transferred from the digital camera 30, it is determined whether or not there is any difference between the previously received image data stored in the display buffer and the currently received image data stored in the reception buffer. When the size of the different portion is greater than the predetermined size, the display range of the display device 14 is set (scroll-controlled) in order to display the different portion. The partial region of the currently received image data corresponding to the display range set by the scroll-control is read out from the display buffer and displayed on the display device 14.

In the present embodiment, when the size of the different portion is greater than the predetermined size, the scroll-control is executed for displaying the different portion. Alternatively, the necessity of the scroll-control may be determined additionally considering the color information included in the different portion and the shape of the different portion.

In the first through fourth embodiments, the scroll-control is executed for moving the display range G2. That is, the display range is moved over the screen image. However, the present invention is not limited to the above embodiments. It is possible to instantaneously move the display range without displaying the movement process of the display range.

The present invention is not limited to the above-described embodiments. In practice, various modifications may be made without departing from the spirit of the invention. The above-described embodiments include inventions in various stages, and various inventions can be derived from proper combinations of structural elements disclosed herein. For example, even if some structural elements in all the structural elements disclosed in the embodiments are omitted or combined, if the problem described in the “Background of the Invention” can be solved and the advantageous effect described in the specification can be achieved, the structure without such structural elements or with a combination of such structural elements can be derived as an invention.

What is claimed is:

1. A display control apparatus for a display device which is configured to display a partial image of a screen image, the partial image being in a display range, the apparatus comprising:
a receiving unit which is configured to receive update information which instructs partial update of the screen image;
an update unit which is configured to partially update the screen image in accordance with the received update information; and
a display controller which is configured to move the display range in the screen image such that the display device displays an image of an update area of the screen image when the update area is out of the display range and a size of the update area is larger than a predetermined size.

2. The display control apparatus according to claim 1, wherein the display controller moves the display range in the screen image such that the display device displays an image of a comprehensive area including all of update areas of the screen image when a size of the comprehensive area is larger than a predetermined size.

3. The display control apparatus according to claim 1, further comprising
a movement instructor which is configured to instruct the display controller to or not to move the display range based on a color and/or a shape of the image of the update area when the update area is out of the display range and a size of the update area is larger than a predetermined size.

4. A display control apparatus for a display device which is configured to display a partial image of a screen image, the partial image being in a display range, the apparatus comprising:
a receiving unit which is configured to receive update information which instructs partial update of the screen image;
an update unit which is configured to partially update the screen image in accordance with the received update information; and
a display controller which is configured to move the display range in the screen image such that the display device displays an image of an update area of the screen image when the update area is out of the display range and the image in the update area has a predetermined attribute.

5. A display control apparatus for a display device which is configured to display a partial image of a screen image, the partial image being in a display range, the apparatus comprising:
a receiving unit which is configured to receive a storage instruction which instructs storage a part of the screen image;
a storage unit which is configured to store the part of the screen image in accordance with the storage instruction; and
a display controller which is configured to move the display range in the screen image such that the display device displays an stored image which is stored by the storage unit when the stored image is out of the display range and a size of the stored image is larger than a predetermined size.

6. A display control apparatus for a display device which is configured to display a partial image of a screen image, the partial image being in a display range, the apparatus comprising:
a detection unit which is configured to detect a difference between first image data and second image data;
a determination unit which is configured to determine whether or not a size of a differential area between the first image data and the second image data is greater than a predetermined size; and
a display controller which is configured to move the display range in the screen image such that the display device displays an image of the differential area when the determination unit determines that the size of the differential area is greater than the predetermined size.

7. A computer program for a display control apparatus for a display device which is configured to display a partial image of a screen image, the partial image being in a display range, the program being stored in a computer readable medium, and the program comprising:
receiving update information which instructs partial update of the screen image;
partially updating the screen image in accordance with the received update information; and
moving the display range in the screen image such that the display device displays an image of an update area of the screen image when the update area is out of the display range and a size of the update area is larger than a predetermined size.

8. A computer program for a display control apparatus for a display device which is configured to display a partial image of a screen image, the partial image being in a display range, the program being stored in a computer readable medium, and the program comprising:
receiving update information which instructs partial update of the screen image;
partially updating the screen image in accordance with the received update information; and
moving the display range in the screen image such that the display device displays an image of an update area of the screen image when the update area is out of the display range and the image in the update area has a predetermined attribute.

9. A computer program for a display control apparatus for a display device which is configured to display a partial image of a screen image, the partial image being in a display range, the program being stored in a computer readable medium, and the program comprising:
receiving a storage instruction which instructs storage a part of the screen image;
storing the part of the screen image in accordance with the storage instruction; and
moving the display range in the screen image such that the display device displays an stored image which is stored by the storage unit when the stored image is out of the display range and a size of the stored image is larger than a predetermined size.

10. A computer program for a display control apparatus for a display device which is configured to display a partial image of a screen image, the partial image being in a display range, the program being stored in a computer readable medium, and the program comprising:
detecting a difference between first image data and second image data;
determining whether or not a size of a differential area between the first image data and the second image data is greater than a predetermined size; and
moving the display range in the screen image such that the display device displays an image of the differential area when it is determined that the size of the differential area is greater than the predetermined size.
